(19) United States
(12) Patent Application Publication
(10) Pub. No.: US 2017/0026739 A1
(43) Pub. Date: Jan. 26, 2017

(54) SPEAKER AND HEADPHONE DEVICE

(71) Applicant: JVC KENWOOD CORPORATION, Yokohama-shi (JP)

(72) Inventors: Yasuhiro MIWA, Yokohama-shi (JP); Hikaru NAGATA, Yokohama-shi (JP)

(21) Appl. No.: 15/214,007

(22) Filed: Jul. 19, 2016

(30) Foreign Application Priority Data
Jul. 24, 2015 (JP) 2015-146805

(51) Int. Cl. H04R 1/28; H04R 1/32; H04R 1/10

(52) U.S. Cl. CPC H04R 1/2823; H04R 1/1066; H04R 1/323

(57) ABSTRACT

A speaker includes: an open-backed speaker unit, a housing, and a fin unit. The housing is disposed so as to cover a rear side of the speaker unit, and forms a back cavity with the speaker unit. The fin unit is disposed in the back cavity, and includes an annular or arc-like fin, which approaches a rear side of the housing as going from a center of the speaker unit toward an outer diameter side thereof, and expands in diameter as separating from the speaker unit.

### CROSS REFERENCE TO RELATED APPLICATION

This application is based upon and claims the benefit of priority under 35 U.S.C. §119 from Japanese Patent Application No. 2015-146805, filed on Jul. 24, 2015, the entire contents of which are incorporated herein by reference.

### BACKGROUND

The present disclosure relates to a speaker and a headphone device, each of which uses open-backed speaker units.

In a speaker composed by including a speaker unit and an enclosure, open-backed ones are sometimes used for the speaker units.

Moreover, for speaker units used in a so-called overhead-type headphone device that include a headband, the open-backed ones are frequently used. The open-backed speaker unit has an opening on the back (the outside, for example) surface of a case of the speaker unit, and emits a sound not only from the front (the inside, for example) surface, but also from the back surface.

An overhead-type headphone device including the open-backed speaker units is described in Japanese Unexamined Patent Application Publication No. 2012-080219.

### SUMMARY

Usually, it is empirically known that in a speaker (speaker system) including the open-backed speaker unit and the enclosure to which the speaker unit is attached, a reproduction volume in the bass range is increased as the depth of the enclosure is longer.

In the overhead-type headphone device, back covers of housing portions which house the speaker units and are put on the ears correspond to the enclosures, and the housing portions correspond to the speakers.

Accordingly, it is examined to achieve an increase of the production volume of the bass range, by elongating the depth of the housing portions; however, it is difficult to form the housing portions in the headphone device into a shape with a long depth from the viewpoint of design and enhancement of fitting property to the ears.

Therefore, in such a speaker or a headphone device, each of which has a short depth, it is desired to make an idea to increase the production volume of the bass range without elongating the depth of the enclosures or the back covers.

A first aspect of the embodiments provides a speaker including: an open-backed speaker unit; a housing which is disposed so as to cover a rear side of the speaker unit, and forms a back cavity with the speaker unit; and a fin unit, which is disposed in the back cavity, and includes an annular or arc-like first fin expanding in diameter, so as to approach a rear side of the housing as going from a center of the speaker unit toward an outer diameter side of the speaker unit.

A second aspect of the embodiments provides a headphone device including: a pair of the speakers according to the above-mentioned configuration; and a headband that couples the pair of speakers to each other.

### BRIEF DESCRIPTION OF THE DRAWINGS

FIG. 1 is a perspective view illustrating an overall configuration of a headphone device 51 as an example of a headphone device according to at least one embodiment.

FIG. 2 is a perspective cross-sectional view illustrating a housing 1 in the headphone device 51.

FIG. 3 is a perspective assembly view illustrating the housing 1.

FIG. 4 is a rear view of a speaker unit 5 housed in the housing 1.

FIG. 5 is a perspective view illustrating a fin unit 12 provided in the housing 1.

FIG. 6 is a perspective view of a fin unit 12 when viewed from a side in a rear direction.

FIG. 7 is a front view illustrating the fin unit 12.

FIG. 8 is a schematic cross-sectional view of the housing 1.

FIG. 9 is a cross-sectional view illustrating a housing 101 as a comparative example, which does not include the fin unit 12.

FIG. 10 is a graph illustrating sound pressure frequency characteristics of the housing 1 and the housing 101.

FIG. 11 is a schematic view for explaining a cross-sectional area of a sound which is emitted from a rear of the speaker unit 5 in a sound propagation path in the housing. 1.

### DETAILED DESCRIPTION

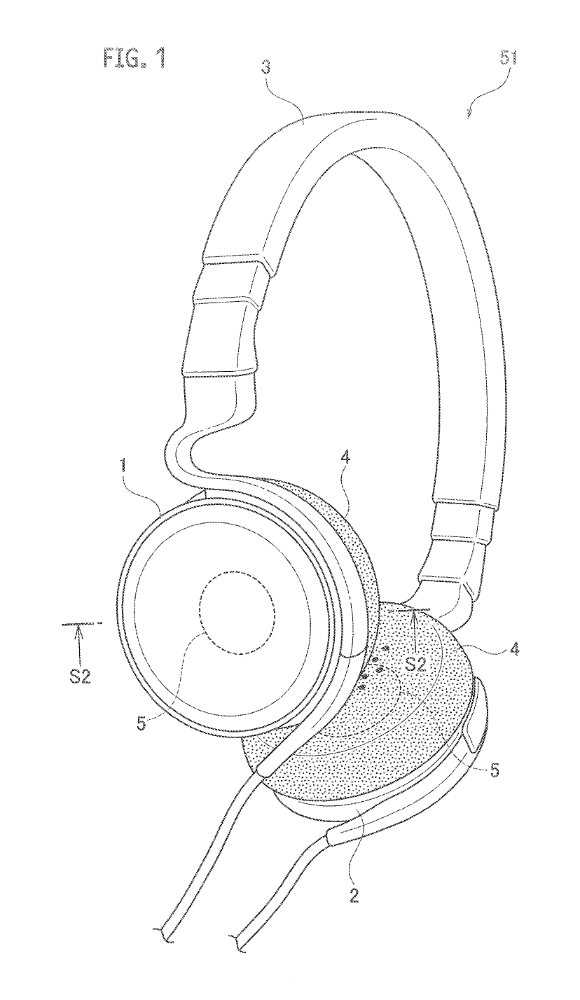

By using FIG. 1 to FIG. 11, a description is made of a headphone device according to the embodiments by a headphone device 51 as a preferred example.

FIG. 1 is an exterior perspective view showing the headphone device 51. The headphone device 51 is of an overhead type, and includes: a housing 1 put on the left ear when used; a housing 2 put on the right ear when used; and a curved headband 3 that couples the housing 1 and the housing 2 to each other.

Each of the housings 1 and 2 is formed into a columnar shape that is approximately flat, and a soft ear pad 4 is attached to each thereof, so as to be freely detachable. In the inside of each of the housings 1 and 2, a speaker unit 5 is housed. The shape of the housing 1 and the shape of the housing 2 are the same, and accordingly, a specific description is made below of the shape of the housing 1.

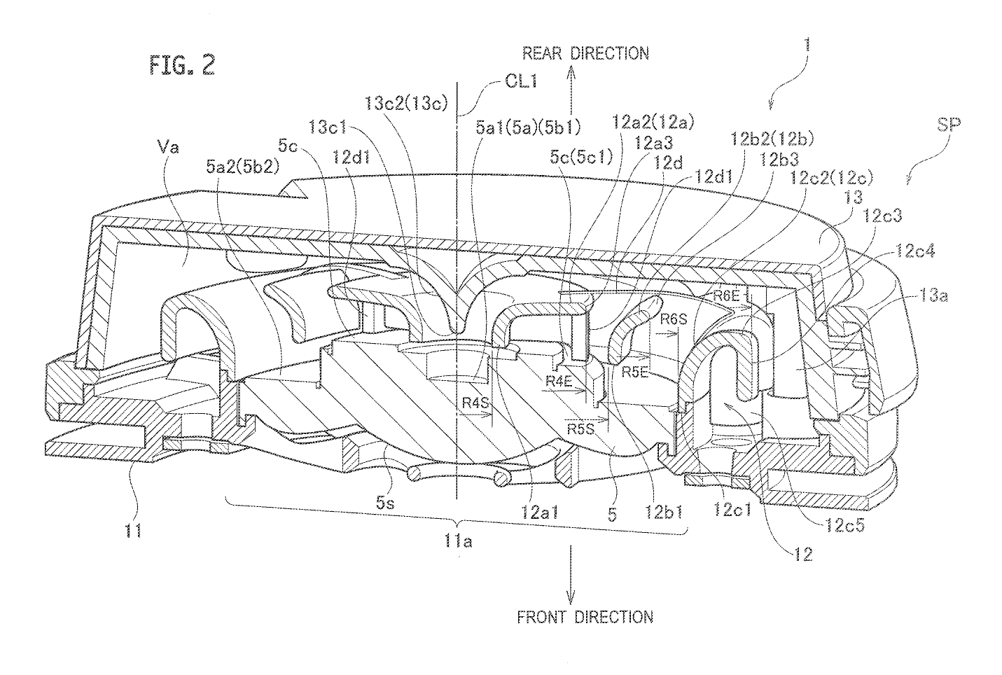

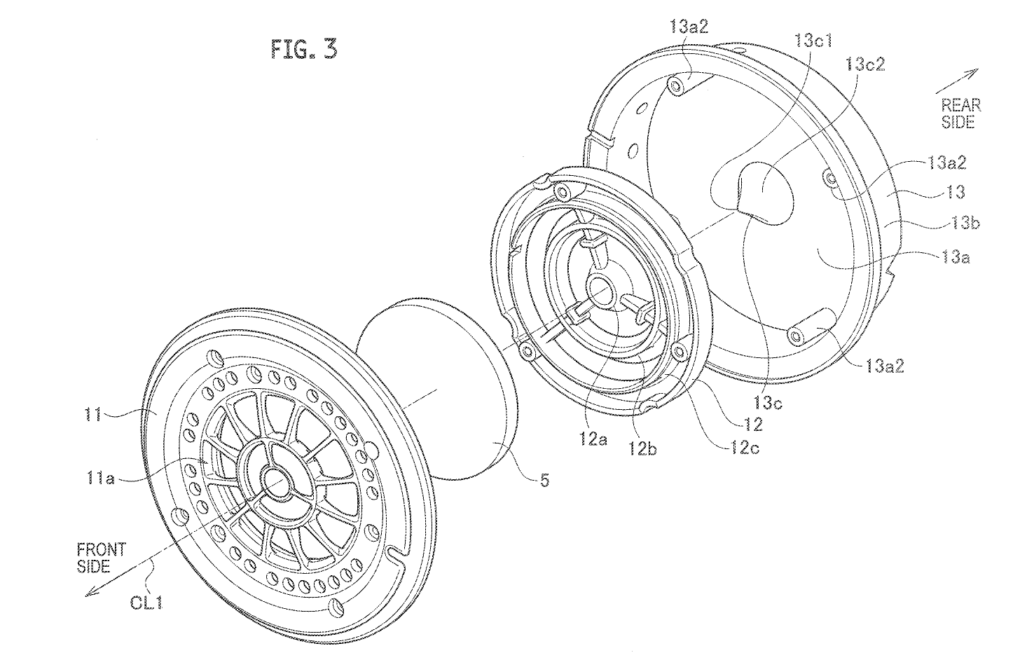

FIG. 2 is a perspective cross-sectional view of the housing 1 in FIG. 1, which is taken along an S2-S2 position. FIG. 2 shows a speaker SP. FIG. 3 is a perspective assembly view of the housing 1. In FIG. 2 and FIG. 3, the ear pad 4 is not shown. Moreover, in the following description, a front direction and a rear direction are determined, as shown in FIG. 2. When the headphone device 51 is being used, the ear is located on the side in the front direction, and the rear direction is the direction apart from a head.

As shown in FIG. 2 and FIG. 3, the housing 1 has a baffle plate 11 on the side thereof serving as the front direction. The baffle plate 11 is formed into a disc shape, and the center portion thereof is formed as a sound-emitting portion 11a, which has a radial grid shape that allows air to flow through.

In an attitude where the baffle plate 11 side is front, the speaker unit 5 is disposed on the rear side (the side in the rear direction) of the sound-emitting portion 11a in the baffle plate 11. In FIG. 3, the speaker unit 5 is illustrated schematically in a disc shape.

The housing 1 includes: a fin unit 12 which is disposed on the side of the speaker unit 5 in the rear direction and is fixed to the baffle plate 11 by a screw, while sandwiching the speaker unit 5 therebetween; and a flat, pan-like back cover 13 that is fixed to the baffle plate 11 by the screw, so as to cover the speaker unit 5 and the fin unit 12.

By being surrounded by the baffle plate 11 and the back cover 13, a space is formed, which substantially becomes the back cavity Va (refer to FIG. 2), and is hermetically sealed on the side of the speaker unit 5 in the rear direction. Hereinafter, the back cavity Va is referred to as the space Va.

As shown in FIG. 2, the speaker unit 5 includes: a case 5c; and a diaphragm 5s supported on the case 5c on a side thereof in the front direction.

The speaker unit 5, the fin unit 12, and the back cover 13 are formed to have an approximately circular contour when viewed from above, and are assembled to one another while taking individual central axes thereof as a common central axis CL1.

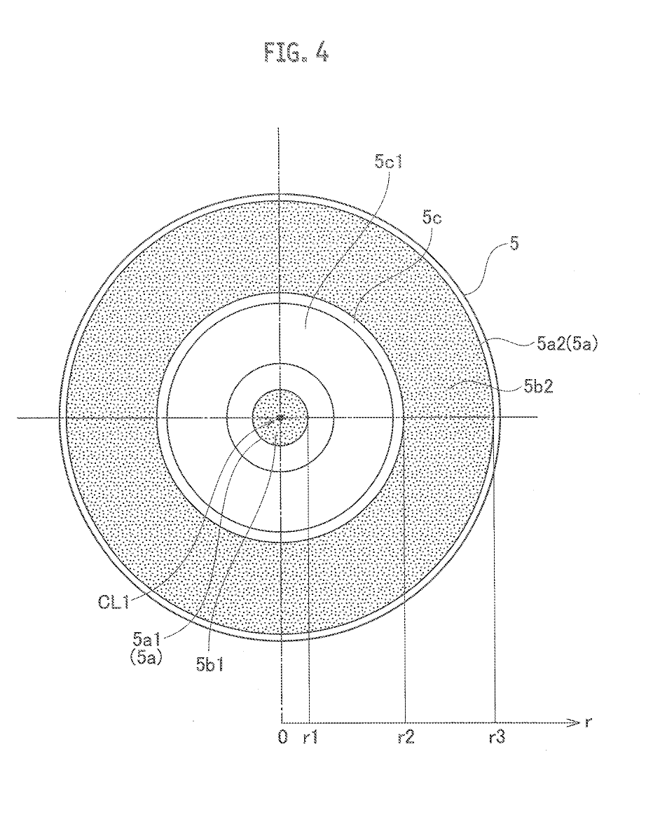

Next, a description is made of the speaker unit 5, also with reference to FIG. 4. FIG. 4 is a rear view of the speaker unit 5. The speaker unit 5 is of an open-backed type exhibiting a flat disc shape. Hence, at a time when a voice is outputted, a sound generated by vibrations of the diaphragm 5s is emitted not only from the front, but also from the rear sound-emitting portion 5a on the rear. The case 5c of the speaker unit 5 includes a sound-emitting hole (not shown) on the side serving as the front direction, and includes the rear sound-emitting portion 5a as an opening also on a side serving as the rear direction.

Specifically, the speaker unit 5 includes, as the rear sound-emitting portion 5a: a central sound-emitting portion 5a1 provided as a circular range, with a radius r1 about a position of the central axis CL1 taken as a center; and an annular sound-emitting portion 5a2 provided as an annular range between a radius r2 and a radius r3. In this example, the inner edge and the outer edge of the annular sound-emitting portion 5a2 are individually circular, and are similar to each other.

Onto the central sound-emitting portion 5a1 and the annular sound-emitting portion 5a2, an acoustic filter 5b1 and an acoustic filter 5b2, which are individually formed of foamed resin sheets or the like, are attached, respectively.

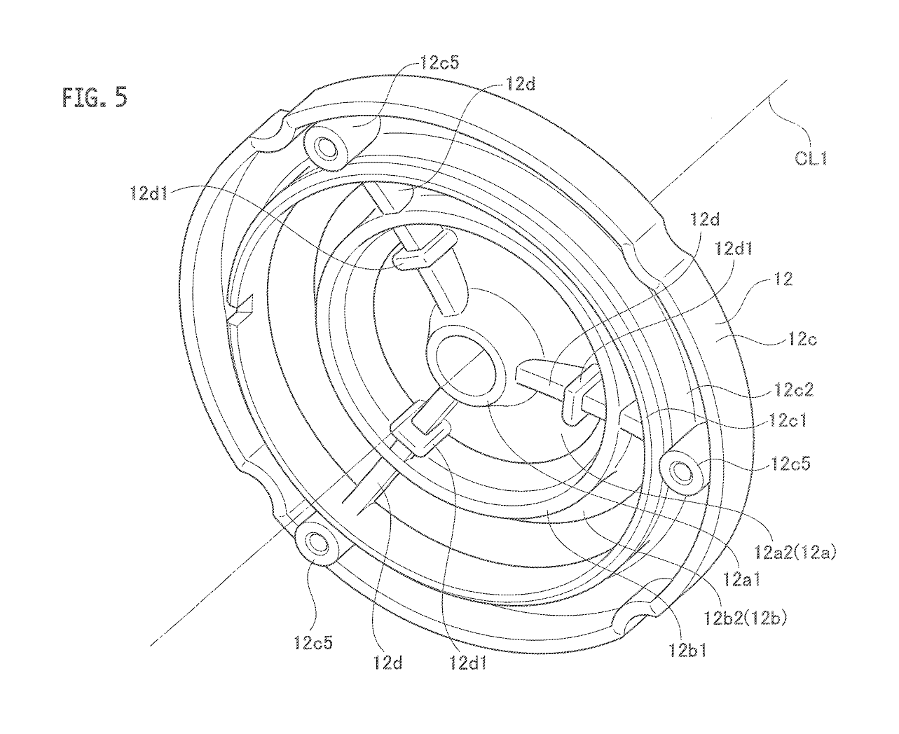

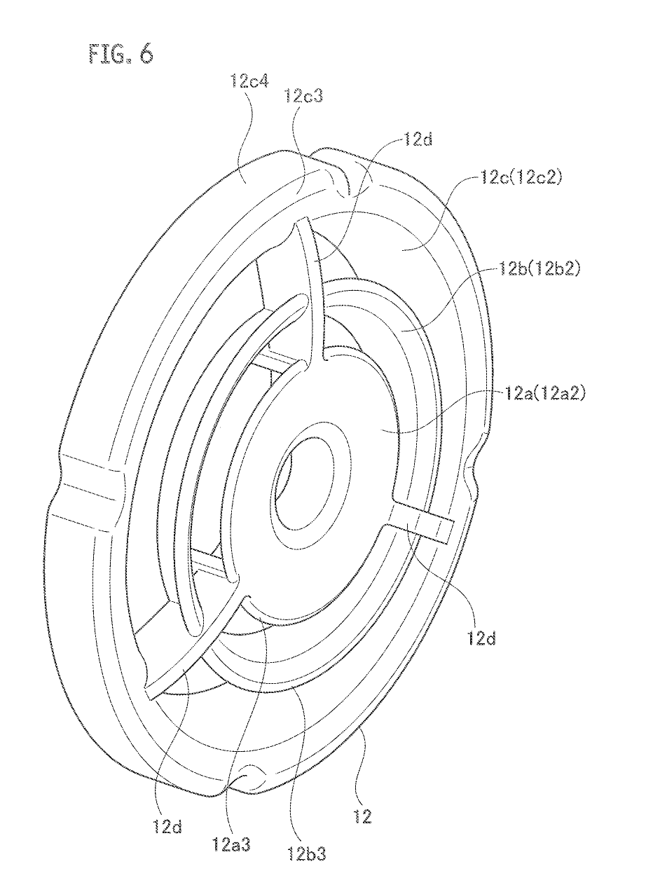

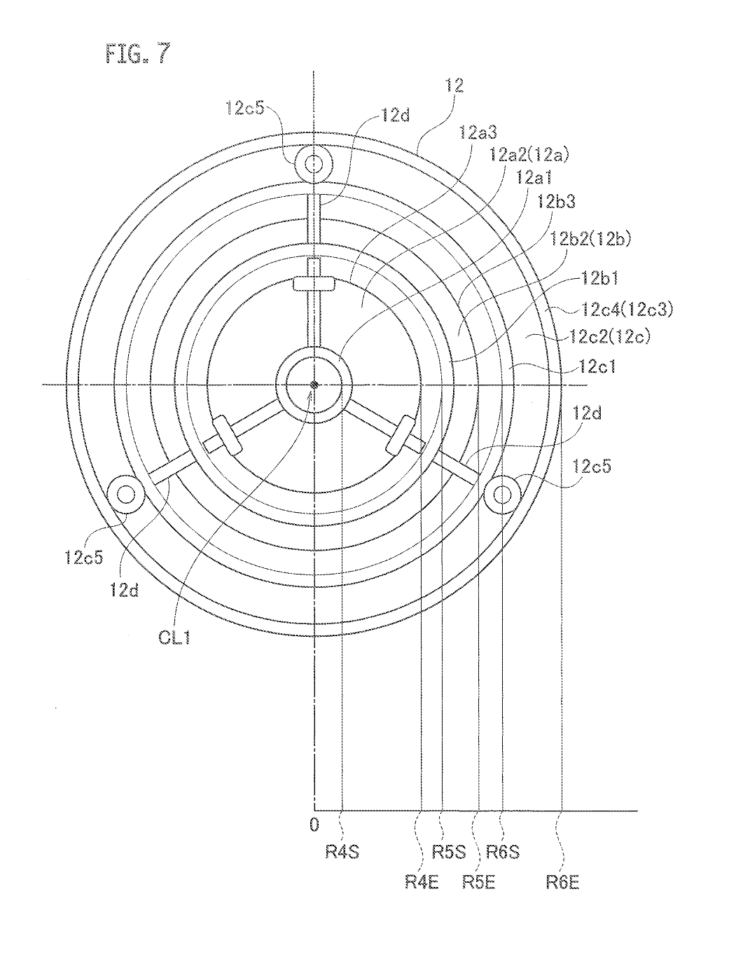

Next, a description is made of the fin unit 12, mainly with reference to FIG. 5 through FIG. 7. FIG. 5 is an enlarged view of the fin unit 12 shown by the perspective view in FIG. 3. FIG. 6 is a perspective view of the fin unit 12, when viewed from the side in the rear direction. FIG. 7 is a frontal view of the fin unit 12.

While taking the central axis CL1 as a center, the fin unit 12 is formed of resin by including: three annular fins 12a, 12b, and 12c, which are concentric with one another, but are different from one another in diameter; and three radial support beams 12d, which couple the fins 12a through 12c to one another.

As shown in FIG. 2 and FIG. 5, in the respective support beams 12d, the ribs 12d1 are formed, which extend in a circumferential direction and protrude in the front direction.

The three fins 12a to 12c are formed into annular or arcuate shapes by including diameter-expanded portions 12a2 to 12c2, which are set to have minimum diameters on side-end portions 12a1 to 12c1 in the front direction, and expand in diameter as going in the rear direction. Here, a description is made of trumpet-like ones, which are formed into annular shapes and extend toward the rear direction. The fins 12a to 12c are formed into arcuate shapes in the case where the fins 12a to 12c cannot be formed into the annular shapes, or wiring portions overlap annular portions since terminals and the like are provided in the inside of the housing 1.

A specific description is made of the shapes of the fins 12a to 12c, mainly with reference to FIG. 2 and FIG. 7. In the fin 12a, an in radius of a front-side end portion 12a1 thereof is defined as R4S, and the fin 12a has such an annular diameter-expanded portion 12a2, which gradually expands in diameter as going from the front-side end portion 12a1 toward the rear direction, and reaches the rear-side end portion 12a3 with the radius R4E. The fin 12a approaches the rear side of the housing 1 (back cover 13) as going from the center of the speaker unit 5 toward the outer dimeter side thereof.

In the fin 12b, an in radius of a front-side end portion 12b1 thereof is defined as R5S larger than a radius R4E, and the fin 12b has such an annular diameter-expanded portion 12b2, which gradually expands in diameter as going toward the rear direction, and reaches a rear-side end portion 12b3 with a radius R5E. The fin 12b approaches the rear side of the housing 1 as going from the center of the speaker unit 5 toward the outer diameter side thereof.

In the fin 12c, an in radius of the front-side end portion 12c1 thereof is defined as R6S larger than the radius R5E, and the fin 12c has such an annular diameter-expanded portion 12c2, which gradually expands in diameter as going toward the rear direction, and reaches the rear-side end portion 12c3 with the radius R6E. The fin 12c approaches the rear side of the housing 1 as going from the center of the speaker unit 5 toward the outer diameter side thereof.

Moreover, the fin 12c has a return fin portion 12c4, which is connected to the rear-side end portion 12c3, extends in the front direction into an annular shape with a radius R6E that is approximately the same radius, and serves for elongating the propagation distance of the sound emitted from the rear sound-emitting portion 5a.

The fin 12c has three bosses 12c5, which extend in the front direction and separate from one another in the circumferential direction at positions corresponding to the support beams 12d on the side serving as the front direction of the diameter-expanded portion 12c2. Pilot holes are formed in the bosses 12c5, and the baffle plate 11 is tightened and fixed to the bosses 12c5 by tapping screws (not shown) from the side in the front direction.

In this tightened and fixed state, the ribs 12d1, which are individually provided on the three support beams 12d, abut against unopened portions 5c 1 with a radius r1 to a radius r2 (refer to FIG. 4) in the case 5c of the speaker unit 5. In such a way, the speaker unit 5 is held between the baffle plate 11 and the fin unit 12, without a gap in the front/rear direction.

Next, a description is made of the back cover 13. As shown in FIG. 3, the back cover 13 is formed of resin by including a disc-like bottom wall 13a and a side wall 13b, erected annularly from the circumference of the bottom wall 13a.

On positions of the bottom wall 13a which are close to the side wall 13b, four bosses 13a2 are erected apart from one another in the circumferential direction. Pilot holes are formed in the bosses 13a2, and the baffle plate 11 is tightened and fixed to the bosses 13a2 by tapping screws (not shown) from the side in the front direction.

By such tightening and fixing, the space Va, surrounded by the baffle plate 11, the speaker unit 5, and the back cover 13 is substantially formed as the back cavity in a hermetically sealed state.

On the bottom wall 13a, a conic protruding portion 13c is formed, which has an apex 13c1 on the central axis CL1. An inclined circumferential surface 13c2 of the protruding portion 13c is formed to be a recessed surface on a radial cross section.

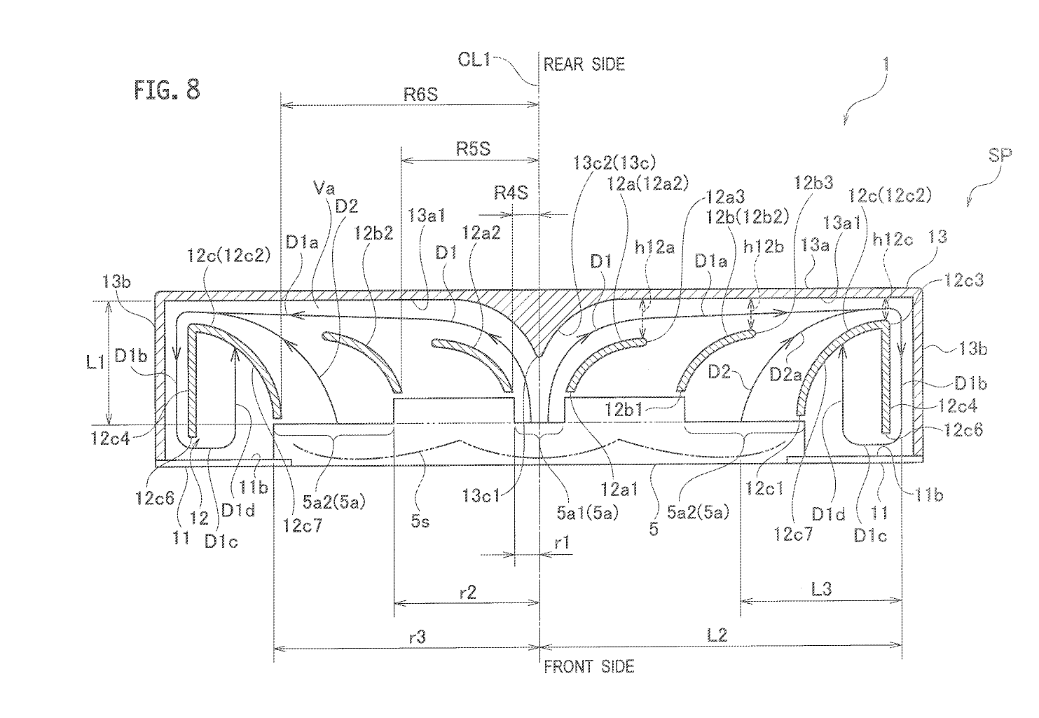

FIG. 8 is a schematic cross-sectional view for explaining a positional relationship in the housing 1 between the rear sound-emitting portion 5a of the speaker unit 5 and the fins 12a to 12c of the fin unit 12 in the diameter direction and the front/rear direction. FIG. 8 illustrates the perspective cross-sectional shape of FIG. 2 into a schematic planar shape.

In FIG. 8, both of the central sound-emitting portion 5a1 and the annular sound-emitting portion 5a2 are located at the same position in the front/rear direction, and the distance in the front/rear direction between this position and the inner surface 13a1 of the bottom wall 13a is defined as distance L1.

As shown in FIG, 8, the front-side end portion 12a1 of the annular fin 12a is located at a position approximately corresponding to an outer circumferential edge of the central sound-emitting portion 5a1 of the speaker unit 5. That is, the radius r1 and the radius R4S are values relatively approximate to each other. For example, it is recommended that the radius R4S may stay within the range of ±5% of the radius r1.

The front-side end portion 12b1 of the annular fin 12b is located at a position approximately corresponding to an inner circumferential edge of the annular sound-emitting portion 5a2 of the speaker unit 5. That is, the radius r2 and the radius R5S are values relatively approximate to each other. For example, it is recommended that the radius R5S may stay within the range of ±10% of the radius r2.

The front-side end portion 12c1 of the annular fin 12c is located at a position approximately corresponding to an outer circumferential edge of the annular sound-emitting portion 5a2 of the speaker unit 5. That is, the radius r3 and the radius R6S are values relatively approximate to each other. For example, it is recommended that the radius R6S may stay within the range of ±15% of the radius r3.

The fin 12a is smaller in diameter than the fin 12b and the fin 12c, and is located inside of the fin 12b and the fin 12c, and accordingly, the fin 12a is an inner fin with respect to the fin 12b and the fin 12c. In a similar way, the fin 12b is an inner fin with respect to the fin 12c.

If the fin 12c is the first fin, then the fin 12b or the fin 12a is the second fin that is the inner fin. If the fin 12b is the first fin, then the fin 12a is the second fin that is the inner fin. The fin unit 12 needs only to include at least one fin. In a case where the fin unit 12 includes the first fin and the second fin, there needs to be only one second fin.

The fins 12a to 12c are provided to separate from the case 5c of the speaker unit 5 in the rear direction, so as to make a gap with the case 5c without contacting the case 5c. In such a way, at an output time of the speaker unit 5, contact noise between the case 5c and the fins 12a to 12c is not generated.

The apex 13c1 of the protruding portion 13c of the back cover 13 is located between the front-side end portion 12a1 and the rear-side end portion 12a3 of the fin 12a in the front/rear direction.

The housing 1 is configured so that, by the above-mentioned configuration including the fin unit 12 and the protruding portion 13c, the sound emitted from the rear sound-emitting portion 5a into the space Va can propagate for a long distance, in comparison with the case where the fin unit 12 and the protruding portion 13c are not present (like a conventional housing).

Moreover, the fin unit 12 is disposed as a partition wall between the rear sound-emitting portion 5a and the inner surface 13a1 of the back cover 13. Hence, by the fact that the fin unit 12 is provided, a so-called return sound is reduced, which is emitted from the rear sound-emitting portion 5a, is reflected on the inner surface 13a1, and returns to the rear sound-emitting portion 5a.

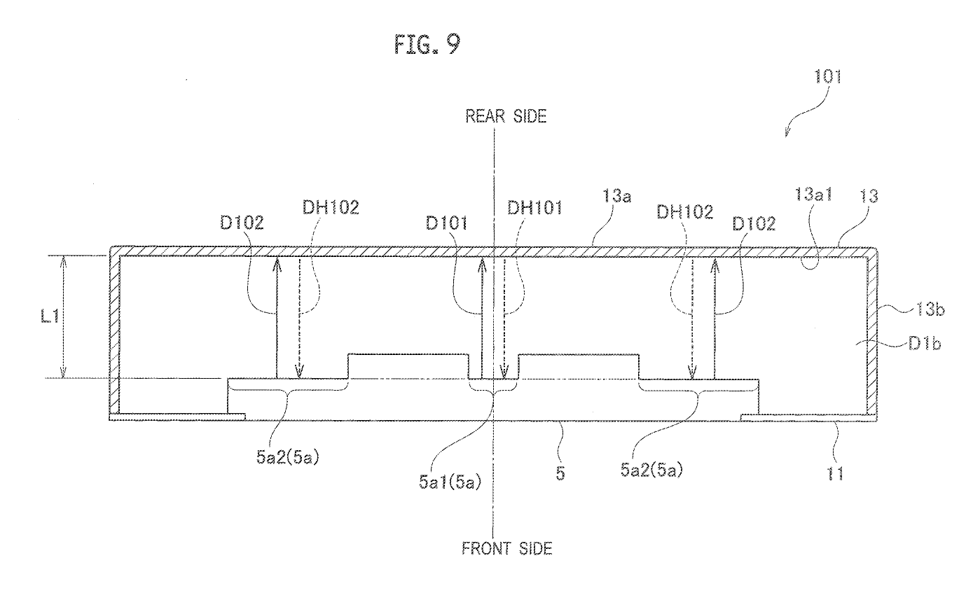

FIG. 9 is a cross-sectional view showing a housing 101 as a comparative example, in which the fin unit 12 and the protruding portion 13c are deleted from the housing 1. Specifically, FIG. 9 is a view explaining a propagation mode example of the sound when an impulse signal is inputted to the speaker unit 5.

In the housing 101, upon propagating by a distance L1 in the rear direction, a central emission sound D101 and an annular emission sound D102, which are emitted in the rear direction from the central sound-emitting portion 5a1 and the annular sound-emitting portion 5a2, reach the inner surface 13a1 of the bottom wall 13a serving as a barrier.

Then, the central emission sound D101 and the annular emission sound D102 are reflected on the inner surface 13a1, and return as reflected sounds DH101 and DH102 to the central sound-emitting portion 5a1 and the annular sound-emitting portion 5a2.

As described above, in the housing 101, propagation distances of the central emission sound D101 and the annular emission sound D102 become the distance L1.

In contrast, in the housing 1 shown in FIG. 8, a central emission sound D1, which is emitted from the central sound-emitting portion 5a1 in the rear direction, passes through a path between the diameter-expanded portion 12a2 of the fin 12a and the inclined circumferential surface 13c2 of the protruding portion 13c, travels in the rear direction by being guided by these, and in addition, propagates outward in the diameter direction thereby. By the fact that the protruding portion 13c is disposed, the propagation of the sound is accelerated, which is made outward in the diameter direction. Even when the protruding portion 13c is not disposed, the central emission sound D1, which is emitted from the central sound-emitting portion 5a 1 in the rear direction, propagates outward in the diameter direction.

Then, the central emission sound D1 propagates outward in the diameter direction, along the inner surface 13a1 of the bottom wall 13a (arrow-indicated path D1a). Subsequently, the central emission sound D1 propagates toward the front between the side wall 13b and the return fin portion 12c4 (arrow-indicated by D1b). After this, the central emission sound D1 propagates toward the central axis CL1 between a front-side end portion 12c6 of the return fin portion 12c4 and the rear 11b of the baffle plate 11 ( arrow-indicated path D1c), and thereafter, reaches a surface 12c7 on the frontal side of the diameter-expanded portion 12c2 of the fin 12c (arrow-indicated arrow D1d).

That is, the propagation path of the central emission sound D1 becomes a path shown by the arrow-indicated path D1a to the arrow-indicated path D1d, and the propagation distance thereof becomes approximately the distance obtained by adding two times and a half the distance L1 and the distance L2 to each other. The distance L2 is the distance from the central axis CL1 to a midpoint between the side wall 13b and the return fin portion 12c4.

Meanwhile, the annular emission sound D2, which is emitted from, the annular sound-emitting portion 5a2 in the rear direction, passes between the diameter-expanded portion 12b2 of the fin 12b and the diameter-expanded portion 12c2 of the fin 12c, travels in the rear direction by being guided by these, and in addition, propagates outward in the diameter direction thereby. Then, the annular emission sound D2 reaches the surface 12c7 on the frontal side of the diameter-expanded portion 12c2 of the fin 12c, through a propagation path similar to that of the central emission sound D1, through such a path shown by the path arrows D1b to D1d.

That is, the propagation path of the annular emission sound D2 becomes such a path shown by the path arrow D2a and the path arrows D1b to D1d, and the propagation distance thereof becomes approximately a distance obtained by adding two times and a half the distance L1 and the distance L3 to each other. The distance L3 is the distance between such a radial center position of the annular sound-emitting portion 5a2, and the maximum-diameter position of the distance L2.

As described above, the housing 1 includes the fin unit 12, whereby, even when the depth of the housing 1 is equal to the depth of the housing 101, propagation path lengths (propagation distances) of the central emission sound D1 and the annular emission sound D2 in the housing 1 are remarkably long. As described above, such a configuration in which the propagation path of the central emission sound D1 and the propagation path of the annular emission sound D2 join together is adopted, whereby it becomes easy for the sounds emitted from the sound-emitting portions 5a1 and 5a2 to reach path ends farthest from the sound-emitting portions 5a1 and 5a2 of the propagation paths.

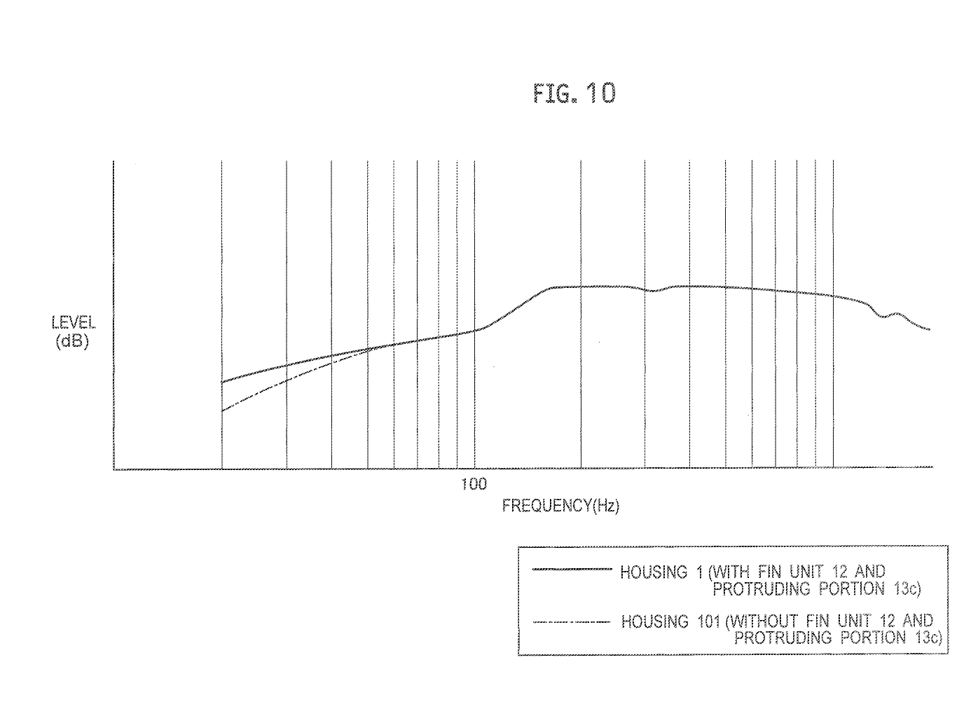

FIG. 10 is a graph illustrating sound pressure frequency characteristics of a sound reproduced by the housing 1 and a sound reproduced by the housing 101 for comparing with each other. A solid line indicates the characteristics of the sound reproduced by the housing 1, and an alternating long and short dash line indicates the characteristics of the sound reproduced by the housing 101.

FIG. 10 shows two characteristics between which there is a difference as to whether or not the fin unit 12 and the protruding portion 13c are present. It is understood that the reproduced sound of the housing 1 including the fin unit 12 and the protruding portion 13c has a higher sound pressure in the bass range, and increases the volume thereof.

As described above in detail, in comparison with the housing 101 that does not include the fin unit 12 and the protruding portion 13c in contrast to the housing 1, in the housing 1, the propagation distance of the sound emitted from the rear sound-emitting portion 5a is longer, though the distance L1 in the front/rear direction of the space Va is the same. It is confirmed that a measured value of the sound pressure in the bass range gets higher.

In the headphone device 51 including the housing 1, a reproduction volume in the bass range is increased without elongating the depth of the housing 1.

The reflected sound DH101, which is generated in the housing 101 and returns to the central sound-emitting portion 5a1, is not generated in the housing 1 since the protruding portion 13c is provided therein. Hence, the reflected sound that returns to the central sound-emitting portion 5a1 does not affect the vibrations of the diaphragm. 5s, and distortion of the reproduced sound by the housing 1 is small.

Moreover, in the housing 1, a major part of the reflected sound, which is emitted from the annular sound-emitting portion 5a2 in the rear direction, is blocked by the fin 12b as it reaches the inner surface 13a1 of the bottom wall 13a and is reflected thereon. Accordingly, the reflected sound that returns to the annular sound-emitting portion 5a2 becomes slight. Hence, an influence of the reflected sound of the annular emission sound D2, which is emitted from the annular sound-emitting portion 5a2 to the vibrations of the diaphragm 5s is slight, and the reproduced sound by the housing 1 also has a little distortion in this case.

In the housing 1, the shapes of the fins 12a to 12c, and the protruding portion 13c of the bottom wall 13a are determined so that a cross-sectional area (cross-sectional area in a direction perpendicular to the propagation direction) of the propagation path of the sound emitted from the annular sound-emitting portion 5a2 is constant.

For example, in FIG. 8, the central emission sound D1, emitted from the central sound-emitting portion 5a1, is guided by the diameter-expanded portion 12a2 of the fin 12a and the inclined circumferential surface 13c2 of the protruding portion 13c, and propagates outward in the diameter direction as propagating in the rear direction.

As shown in FIG. 6 and the like, the fin 12a is formed into an annular shape, and accordingly, the central emission sound D1 propagates around the entire circumference within 360° so as to expand in diameter. Hence, if the cross-sectional area in a unit angle range of the propagation path is constant, then a total cross section of the propagation path expands as the central emission sound D1 is propagating.

It is empirically known that sound quality tends to decrease if the cross-sectional area in the direction perpendicular to the propagation direction, the cross-sectional area being of the propagation path, is changed to a large extent in such an event where the emission sound propagates in the space Va that is the back cavity.

Accordingly, the shapes of the housing 1 and the fin unit 12 are set so that the cross-sectional areas of the central emission sound D1 and the annular emission sound D2, which propagate in the annular shape, is approximately constant irrespective of the diameter.

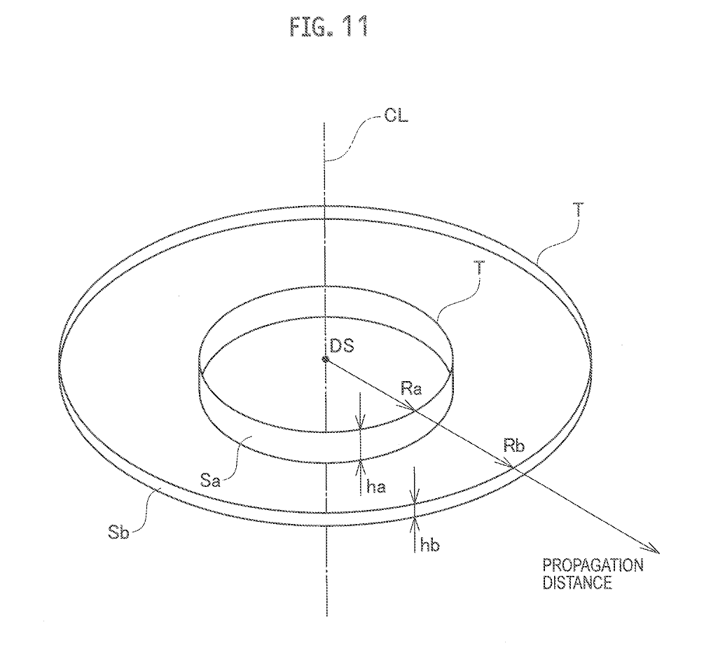

FIG. 11 is a perspective view schematically showing a method of constantly setting the cross-sectional areas. In FIG. 11, with regard to a path T of a sound that is emitted from a sound source DS and propagates in an entire circumference direction, a path width thereof at a position where a radius is Ra is defined as ha, and a path width thereof at a position where a radius is Rb larger than Ra is defined as hb.

The cross-sectional area Sa of the path T at the position Ra is represented as Sa=2nRa×ha, and the cross-sectional area Sb of the path T at the position Rb is represented as Sb=2nRb×hb.

In order to establish that Sa=Sb is the preferred aspect, Equation (1) needs to be established.

hb=(Ra/Rb)×ha (1)

If this method of thinking is applied to the housing 1, then a structure is formed, as shown in FIG. 8. That is, widths in the front/rear direction between the bottom wall 13a and the rear-side end portions 12a3 to 12c3 of the fins 12a to 12c are defined as widths h12a and h12c. Moreover, the respective radii of the rear-side end portions 12a3 to 12c3 are defined as R4E, R5E, and R6E (also refer to FIG. 7).

At this time, path cross-sectional areas S12a, S12b, and S12c at positions of the rear-side end portions 12a3 to 12c3, are represented as in Equations (2) to (4).

S12a=2nR4E×h12a (2)

S12b=2nR5E×h12b (3)

S12c=2nR6E×h12c (4)

Hence, in order to establish S12a=S12b=S12c that is a preferred aspect, Equations (5) and (6) need to be established.

h12b=(R4E/R5E)×h12a (5)

h12c=(R4E/R6E)×h12a (6)

That is, the interval (minimum interval) between a maximum-diameter region of the second fin and the rear (bottom wall 13a) of the housing 1 (back cover 13) is wider than the interval between a maximum-diameter region of the first fin and the rear (bottom wall 13a) of the housing 1 (back cover 13).

The present invention is not limited to the configuration of the above-mentioned embodiments, and is modifiable within the scope without departing from the scope of the present invention.

The headphone device 51 is not limited to the so-called overhead-type including the headband. The headphone device 51 may be other forms of headphones, such as an ear-hanging type headphone, which includes ear-hanging hangers, and are attached to auricles.

The annular sound-emitting portion 5a2 does not have to be an annular area that is continuous and perfect. The annular sound-emitting portion 5a2 may be formed into a C shape-like or arc-like area having a discontinuous portion. The central sound-emitting portion 5a1 and the annular sound-emitting portion 5a2 may be composed of plural holes. In this case, the annular sound-emitting portion 5a2 is disposed so as to form an annular shape or an arc shape.

Moreover, the fins 12a to 12c do not have to be continuously and perfectly annular, either, and may be formed into arc shapes.

In the case where any of the above-described fins 12a to 12c and the annular sound-emitting portion 5a2 are combined with each other, in the case where the fin is arc-like and the annular sound-emitting portion 5a2 is annular, then the above-mentioned effect is achieved within a range of a circumferential direction of the arc-like fin. On the contrary, in the case where the fin is annular and the annular sound-emitting portion 5a2 is arc-like, then the above-mentioned effect is achieved within a range of a circumferential direction of the fin corresponding to the annular sound-emitting portion 5a2 that is arc-like.

If the back cover 13 of the housing 1 is regarded as an enclosure, then the speaker SP is composed including the speaker unit 5 and the back cover 13. The speaker SP is also incorporated in the present disclosure.

For example, in the case where the depth of the speaker SP cannot be elongated owing to design restrictions, the speaker SP can obtain a similar effect to that of the headphone device 51 by adopting the configuration of the embodiments, including the above-mentioned fin unit 12.

What is claimed is:

1. A speaker comprising:
an open-backed speaker unit;
a housing which is disposed so as to cover a rear side of the speaker unit, and forms a back cavity with the speaker unit; and
a fin unit, which is disposed in the back cavity, and includes an annular or arc-like first fin expanding in diameter, so as to approach a rear side of the housing as going from a center of the speaker unit, toward an outer diameter side of the speaker unit.

2. The speaker according to claim 1, wherein the speaker unit comprises a first sound-emitting portion that emits a sound to the rear in a predetermined area, and an end portion of the first fin on the speaker unit side comes close to an outer edge of the first sound-emitting portion while having a shape corresponding to shape of the outer edge.

3. The speaker according to claim 2, wherein the predetermined area is an annular or arc-like area.

4. The speaker according to claim 3, wherein the fin unit comprises an annular or arc-like second fin in which an end portion on the speaker unit side has a shape corresponding to a shape of an inner edge of the predetermined area and expands in diameter so as to approach a rear side of the housing as going from a center of the speaker unit toward an outer diameter side, the second fin being located inside the first fin on an inner diameter side.

5. The speaker according to claim 4, wherein, on the rear, the speaker unit comprises a second sound-emitting portion on an inner diameter side, inside an end portion of the second fin on the speaker unit side.

6. The speaker according to claim 5, wherein an interval between a maximum-diameter region of the second fin and a rear of the housing is wider than an interval between a maximum-diameter region of the first fin and the rear of the housing.

7. A headphone device comprising:
a pair of the speakers according to claim 1; and
a headband that couples the pair of speakers to each other.
